(19) United States
(12) Patent Application Publication
(10) Pub. No.: US 2024/0319403 A1
(43) Pub. Date: Sep. 26, 2024

(54) NEAR WELLBORE CRITICAL GAS RATE CORRELATION FOR OIL AND GAS RESERVOIRS

(71) Applicant: Saudi Arabian Oil Company, Dhahran (SA)

(72) Inventor: Carlos G. Herrera Guevara, Dhahran (SA)

(21) Appl. No.: 18/187,170

(22) Filed: Mar. 21, 2023

(51) Int. Cl. G01V 99/00; E21B 49/00

(52) U.S. Cl. CPC G01V 20/00; E21B 49/00; E21B 2200/20

(57) ABSTRACT

Systems and methods include a computer-implemented method for adjusting a critical line for a wellbore. A separator test is performed for a well that is flowing at unstable conditions. In response to determining that a Turner equation does not predict the critical line for the wellbore, a water gas ratio (WGR) and a gas liquid ratio (GLR) are determined using gas, oil, and water rates from a separator of the well. When a gas relative permeability (K_{rg}), an oil relative permeability (Kᵣₒ), and a water relative permeability (K_{rw}) are available, K_{rw} and Kᵣₒ are adjusted until they match the separator data at critical conditions in a GLR-WGR log-log plot for the well. Otherwise, a field constant C_{field} is adjusted until it matches the separator data at critical conditions in a GLR-WGR log-log plot. The critical line is adjusted based on the WGR.

### TECHNICAL FIELD

The present disclosure applies to determining measurements in gas and oil reservoirs.

### BACKGROUND

Predicting the critical gas rate when a well will stop flowing due to unstable flow demands a good understanding of fluid flow behavior in the reservoir and the wellbore. The Turner equation is a well-recognized equation in the oil and gas industry for use in estimating the critical gas velocity in the wellbore.

### SUMMARY

The present disclosure describes techniques that can be used for determining near wellbore critical gas rate correlations for oil and gas reservoirs. In some implementations, a computer-implemented method includes the following. A separator test is performed for a well that is flowing at unstable conditions. A determination is made, using separator data of the separator test, whether a Turner equation predicts a critical line for a wellbore of the well. In response to determining that the Turner Equation does not predict the critical line for the wellbore, a water gas ratio (WGR) and a gas liquid ratio (GLR) are determined using gas, oil, and water rates from a separator of the well. When a gas relative permeability (K_{rg}), an oil relative permeability (Kᵣₒ), and a water relative permeability (K_{rw}) are available, K_{rw} and Kᵣₒ are adjusted until they match the separator data at critical conditions in a GLR-WGR log-log plot for the well. Otherwise, a field constant C_{field} is adjusted until it matches the separator data at critical conditions in a GLR-WGR log-log plot. The critical line is adjusted based on the WGR.

The previously described implementation is implementable using a computer-implemented method; a non-transitory, computer-readable medium storing computer-readable instructions to perform the computer-implemented method; and a computer-implemented system including a computer memory interoperably coupled with a hardware processor configured to perform the computer-implemented method, the instructions stored on the non-transitory, computer-readable medium.

The subject matter described in this specification can be implemented in particular implementations, so as to realize one or more of the following advantages. For compositional fluid reservoirs, a power law correlation of Gas Liquid Ratio (GLR) vs. Water Gas Ratio (WGR) is found to be useful to estimate the moment a well will start having unstable production. A workflow can be used that is based on the correlation (Equation 3 and Assumptions section, Equation A-35). It was shown that it is easy to extract basic relative permeability and possible range shapes for the relative curves from WGR vs. GLR graphs that match the slope of the power law correlation for other reservoirs that do not have enough data (see FIG. 3). For practical purposes, the power law correlation can be used without relative permeabilities information by just matching the available data using at least one well with separator data at critical conditions (see Equation 4). The correlation helps to assess the value of an oil and gas assets and strategically find reservoir management options with enough time to avoid undesirable production losses (e.g., implementation of WPF (Well Pad Facilities) and CPF (Central Processing Facility) upgrades, gas compression, gas lift, huff and puff, CHS (Chemical Stimulations), and several other options to stabilize the production). Just using a wellbore critical gas rate to estimate unstable flow can result in an over-estimation of the volumes. This impact can be quantified by using the Arps decline analysis of the gas, oil, and water, or by using a reservoir simulation combined with the GLR-WGR correlation (FIG. 5).

The details of one or more implementations of the subject matter of this specification are set forth in the Detailed Description, the accompanying drawings, and the claims. Other features, aspects, and advantages of the subject matter will become apparent from the Detailed Description, the claims, and the accompanying drawings.

### DESCRIPTION OF DRAWINGS

FIG. 1 is a log-log graph showing example results of liquid loading critical gas rate calculations using the Turner equation versus field data, according to some implementations of the present disclosure.

FIG. 2 is a log-log graph showing examples of Gas Liquid Ratio (GLR) vs. Water Gas Ratio (WGR) correlations, according to some implementations of the present disclosure.

FIG. 3 is a graph showing an example of a Corey Exponent of Water Relative Permeability and its impact on matching of the separator tests at critical conditions, according to some implementations of the present disclosure.

FIG. 4 is a log-log graph showing an example of an Oil and Water Relative Permeability and its impact on matching of the separator tests at critical conditions, according to some implementations of the present disclosure.

FIG. 5 is a graph showing an example of a forecast production example, according to some implementations of the present disclosure.

FIG. 6 is a graph showing an example of a ranking example per well and sector for field A, according to some implementations of the present disclosure.

FIG. 7 is a graph showing an example of a reservoir simulation sensitivity at different Critical Gas Rate (CGR) values, according to some implementations of the present disclosure.

FIG. 8 is a graph showing an example of a reservoir simulation sensitivity at different K_{rw} Corey Exponents, according to some implementations of the present disclosure.

FIG. 9 is a flow chart showing an example of a workflow for determining near wellbore critical gas rate correlations for oil and gas reservoirs, according to some implementations of the present disclosure.

FIG. 10 is a flowchart of an example of a method for determining near wellbore critical gas rate correlations for oil and gas reservoirs, according to some implementations of the present disclosure.

FIG. 11 is a block diagram illustrating an example computer system used to provide computational functionalities associated with described algorithms, methods, functions, processes, flows, and procedures as described in the present disclosure, according to some implementations of the present disclosure.

Like reference numbers and designations in the various drawings indicate like elements.

### DETAILED DESCRIPTION

The following detailed description describes techniques for determining near wellbore critical gas rate correlations for oil and gas reservoirs. Various modifications, alterations, and permutations of the disclosed implementations can be made and will be readily apparent to those of ordinary skill in the art, and the general principles defined may be applied to other implementations and applications, without departing from the scope of the disclosure. In some instances, details unnecessary to obtain an understanding of the described subject matter may be omitted so as to not obscure one or more described implementations with unnecessary detail and inasmuch as such details are within the skill of one of ordinary skill in the art. The present disclosure is not intended to be limited to the described or illustrated implementations, but to be accorded the widest scope consistent with the described principles and features.

The techniques of the present disclosure include the use of a diagnostic plot derived from the Darcy flow equation to predict the critical gas rate as a phenomenon happening not only in the wellbore, but also in the reservoir. The present disclosure demonstrates that even if the critical gas rate in the reservoir is linked to the relative permeability, the diagnostic plot can still be done without this knowledge, as the plot clearly shows maximum limits of Water Gas Ratio (WGR) and Gas Liquid Ratio (GLR) where the well will have unstable flow.

The diagnostic tool is supported theoretically and has been proven to be successful for sandstone gas condensate and volatile oil fields under gas injection. The diagnostic tool was also extended for sandstone and carbonates in blowdown scenarios with normal pressure and over-pressure systems. The diagnostic plot can be utilized to guide production and reservoir engineers in decisions and implementation of gas injection strategies, tubing completion changes, artificial lift methods, compression projects, and the use of mechanical/chemical stimulations to protect or reactivate wells. By combining the decline curve analysis or reservoir simulation with the diagnostic plot, it is possible to identify, ahead of time, the moment when the well will reach critical flow conditions and assess, in advance, the reserves that might be at risk. Reservoir simulators have a minimum gas rate constraint option, which can be related to the critical rate in the wellbore, but the constraint at the reservoir level is still required. This constraint can easily be implemented to avoid over-estimation of hydrocarbon production forecasts by using the equation described in the present disclosure or by setting a maximum WGR based on the correlation.

The diagnostic plot described in the present disclosure includes an ease of implementation and rapid identification for well ranking that needs immediate or future interventions. Furthermore, the techniques of the present disclosure illustrate that, with just a single separator test of close critical flow conditions, it is possible to calibrate the diagnostic model for a single field or multiple ones that share similar properties. Some implementations can be used to collect more information, extending the analysis to other reservoir systems with different injection schemes. Some implementation can be used to perform additional reservoir simulation sensitivities including the non-Darcy skin and to finally include the constraint in analytical and reservoir simulation models.

### Usefulness and Objectives of Techniques

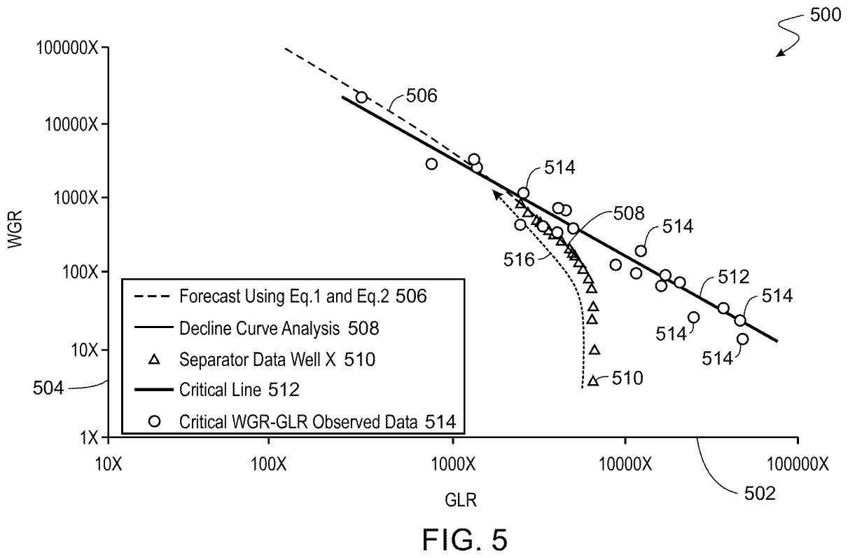

The techniques of the present disclosure can be used to determine if a new well is (or will be) at risk due to unstable flow. Then, the current GLR and WGR of the well can be added, e.g., if the data point is far from the critical line. The well will then be able to meet the avails (refer to FIG. 5). The techniques can be used to rank projects for use in recovering wells that are inactive, then to load all the separator tests for all these wells.

The techniques of the present disclosure can be used to predict when the well will start having unstable flow. Some separator tests can then be performed to forecast and predict the moment when the well will reach the critical line (FIG. 5). Results of the tests can then be used to define possible solutions such as gas injection, gas lift, well pad facility (WPF), and CHS (Chemical Stimulation).

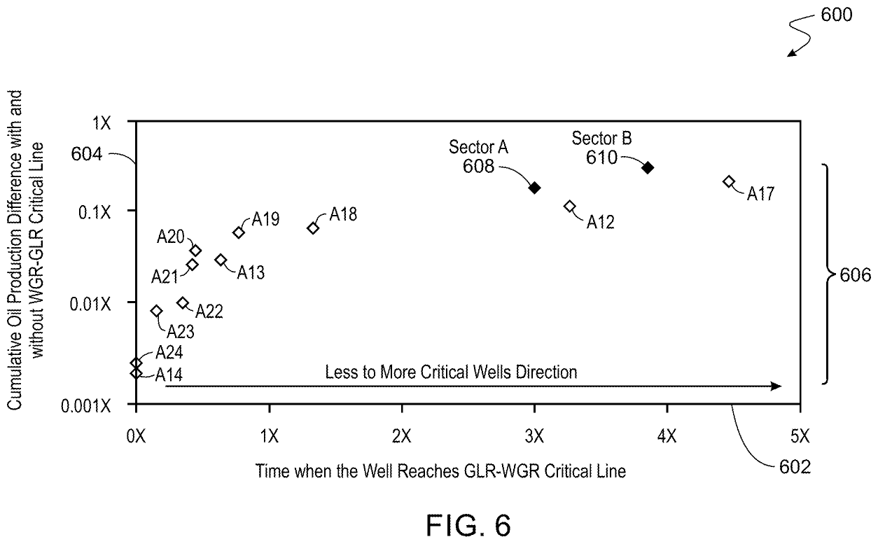

The techniques can be used to identify possible reserves at risk. Forecasts can be performed for each well with and without the GLR-WGR constraint to quantify volumes (FIG. 6). This can help to predict the time to prepare solutions ahead of time.

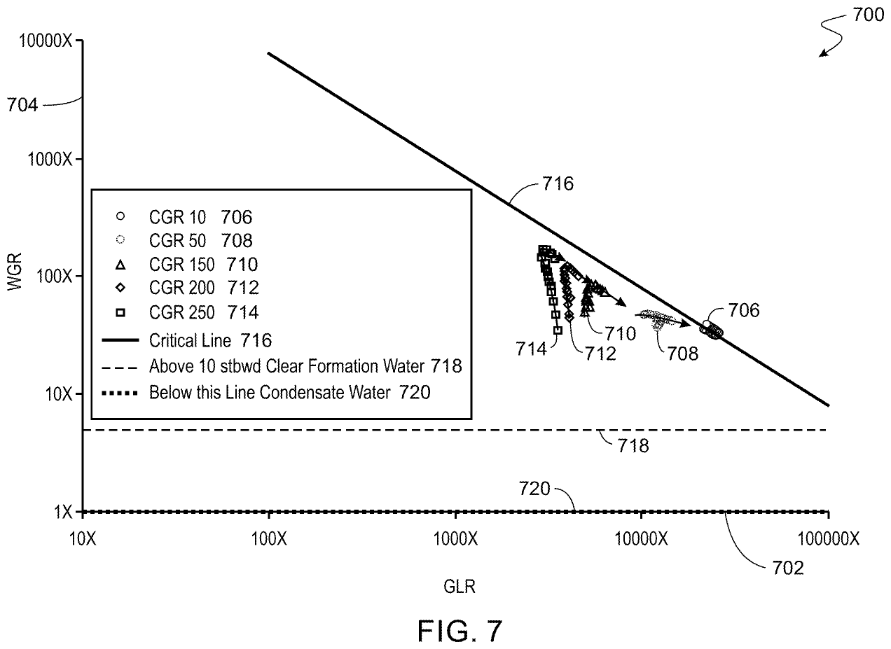

The techniques can be used to perform a quality check of water forecasts coming from analytical or reservoir simulation models. The graph of FIG. 7 can help to identify if the water forecast is good or should be improved. Every well typically has a characteristic trajectory of the GLR-WGR with time (FIG. 7).

### INTRODUCTION

The well-known Turner equation is typically used to estimate the critical gas rate of the well for liquid loading and can be sufficient in certain fields. However, predicting the critical rate in a natural fracture gas and volatile oil reservoirs can be a real challenge, as the lifting of the wells depends highly on gas cycling conditions between injectors and producers. Once this loop is broken by a presence of water, the risk of losing the well's production is eminent and not only arises from the lifting problems in the wellbore, but also leads to gas relative permeability reduction and blockage issues near the wellbore. The techniques of the present disclosure can be extended to gas condensate and volatile oil reservoirs with no natural fractures under blow down production with normal pressure or overpressure systems.

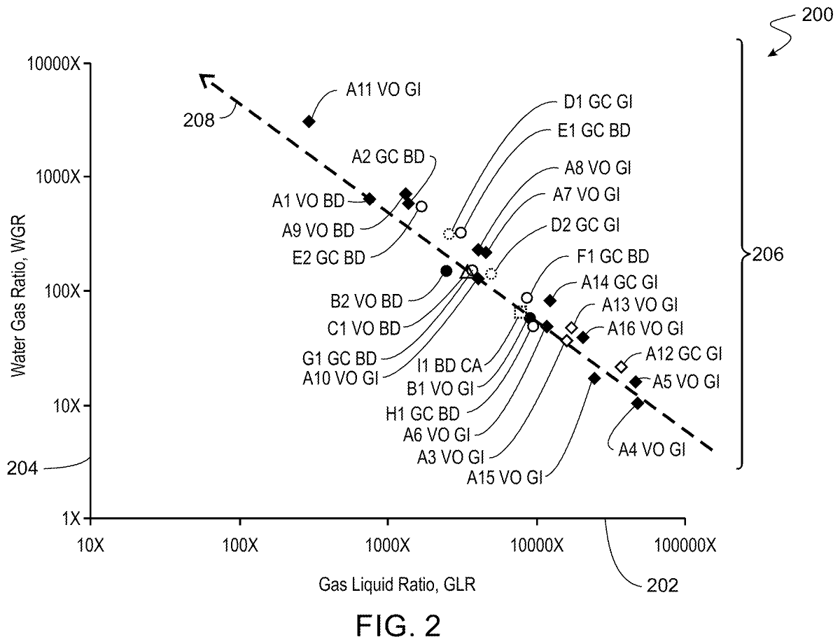

An objective of the techniques of the present disclosure is to use a power law GLR vs. WGR correlation (FIG. 2) as a practical and useful approach for reservoir management. This can be used to estimate unstable flow at the end of production time of a wide range of gas condensate and volatile oil fields. It can be demonstrated that the critical gas rate is highly correlated to the relative permeabilities (Equation 3). This correlation has been found to be very useful in different decision making analysis processes, as it is possible to quantify the risk in hydrocarbon volumes and an occurrence time (FIG. 7). This can help to plan well intervention activities ahead of time (e.g., chemical stimulations and change of completion) and reservoir management for pressure support and sweep options such as drilling new gas injection wells, gas injection conversions, or surface options (e.g., installation of well pad facilities, gas compression or gas lift systems).

Even if this analysis has a theoretical background, it can also be implemented without any knowledge of the relative permeabilities, for example, in green fields where the information is limited. A diagnostic plot can be used as a first screening step. Once it is determined that a well is in the critical zone, the next step is to perform a detailed nodal analysis and try different alternatives to solve the problem.

Water production from aquifers, movable water from transition zones, and water injection or cross flow can impact the production of a well. As a result, solutions can focus on finding the moment at which water production makes a well economically unsustainable in order to avoid or manage this risk as much as possible.

### Critical Gas Rate in the Wellbore

Vertical lift correlations and critical gas rate equations are generally used to estimate the critical point for lifting problems and unstable flow in a wellbore. Corresponding models can be used to predict low critical gas rates.

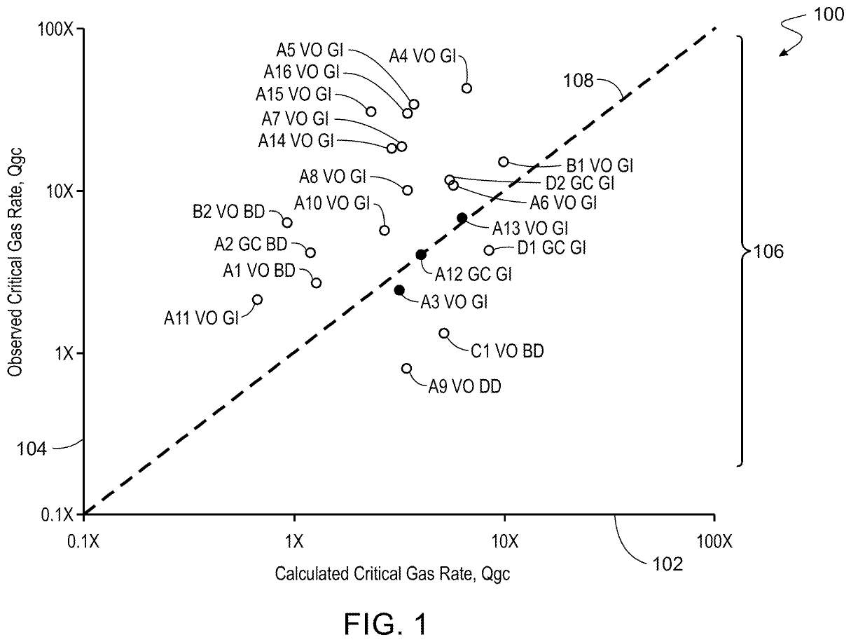

FIG. 1 is a log-log graph 100 showing example results of liquid loading critical gas rate calculations using the Turner equation versus field data, according to some implementations of the present disclosure. FIG. 1 shows, in an X-axis 102, calculated critical gas rates determined using the Turner equation and, in a Y-axis 104, the gas rate of the separator tests at critical conditions. If a liquid loading problem was the reason for the wells to stop flowing, all the points 106 should be close and aligned to a 45° slope line 108.

Based on FIG. 1, the lifting problems of several wells for field A, in this case, are not only related to liquid loading in the wellbore, but some other phenomena are also happening in the reservoir that restrict the mobility of the gas. A well that is flowing at critical condition is a well that shows a wellhead tripping behavior that suggests slug flow (or similar unstable flow regimes) and has signals of liquid loading.

The restriction of the gas flow happens when oil and/or water are flowing, such as in porous media. One way to estimate the multiphasic fluid flow rate in a porous flow rate is using the extended Darcy's Law to multiphasic flow with the relative permeabilities.

It is well known that gas fields with active aquifers can have a good initial and rapid recovery factor, but at a certain time, the trapped gas can stop their production. This behavior can clearly be shown with a material balance P/Z plot. Then, Gas-Water relative permeabilities can play a big role in the flow of gas systems. Typically, the relative permeabilities available for these reservoirs are gas-oil and/or water-oil. However, the gas-water relative permeability measurements are scarce, making it difficult to identify the moment at which the gas mobility is impaired by fluid blockage.

### GLR and WGR-Field Data

It is known that water and oil are the variables related to gas blockage due to the presence of liquids. As such, it is possible to find a production relationship that can reveal that the production issues are not only related to wellbore lifting problems. Several relationships can be determined not to have a clear correlation or trend. These can include Water Gas Ratio (WGR) vs. Reservoir pressure, Gas Liquid Ratio (GLR) vs. Reservoir pressure, WCut vs. GLR, gas-oil rate (GOR) vs. WGR, and WGR vs. Critical Gas Rate (CGR). It was determined that the GLR vs WGR relationship shows the best correlation and can generate the link with production data and the liquid blockage occurring in the reservoir due to multiphasic flow. When the oil is 0 in the GLR, the oil production is 100% correlated with WGR, as both contain the same information. Therefore, the GLR implicitly contains information about the CGR which ultimately impacts the maximum WGR that a well can achieve.

FIG. 2 is a log-log graph 200 showing examples of GLR vs. WGR correlations 206, according to some implementations of the present disclosure. The correlations 206 are for Fields A, B, C, D, E, F, G, H and I based on separator tests of the wells with critical flow conditions. As such, FIG. 2 is a log-log plot of GLR 202 vs WGR 204 using the production from separator tests of wells that were flowing at critical conditions from 2 different sandstone gas condensate (GC) fields and 2 volatile oil (VO) fields with gas injection (GI), 4 gas condensate sandstone fields and 3 volatile oil fields under blow down (BD) depletion, and 1 gas condensate carbonate (CA) reservoir under blowdown depletion showing an envelope where the wells will struggle to flow. The direction of the dashed arrow 208 represents the direction where a higher draw down is required to activate a well. Also in that direction, the CGR increases. FIG. 2 basically is showing that for a well to reach its maximum WGR until it is unstable depends on its GLR (i.e. the amount of oil in the system and its mobility).

WGR (Water Yield) was selected to be the Y-axis as it can easily include the water vapor (also known as condensed water) and uses it to identify the threshold at which formation water starts to produce. This reference value can be obtained from correlations or from field production information combined with water geochemistry analysis.

### Reservoir Critical Gas Rate Equation

In order to model and understand the GLR and WGR observed data collected from wells flowing at critical conditions (FIG. 2), Equations 1 and 2 were derived using several generic reservoir conditions assumptions (See Assumptions section). Equations 1 and 2 are also based on basic algebraic calculations using Darcy's Law for gas, oil, and water rate and replacing them to obtain WGR and GLR (Refer to Assumptions section, Equations A.19 and A.30). The equations show that WGR and GLR depend on relative permeabilities, the average pressure, and non-Darcy skin.

$$GLR ≡ 14 \cdot p \cdot \frac{{k}_{rg}}{( 2.5 \cdot {k}_{ro} + 2 \cdot {k}_{rw} )} \qquad ( 1 )$$

$$WGR ≡ 142 \times 1 {0}^{3} \cdot \frac{1}{p} \cdot \frac{{k}_{rw}}{{k}_{rg}} \qquad ( 2 )$$

where WGR is the water gas ratio, GLR is the gas liquid ratio, p is any pressure between pwf and p reservoir (Assumptions section, Equation A.6), K_{rg} is the gas relative permeability, Kᵣₒ is the oil relative permeability, K_{rw} is the water relative permeability.

Plugging Equation 1 into Equation 2 produces Equation 3 (Assumptions section, Equation A.35). This is the equation that represents the trajectory of the GLR and WGR and defines the critical threshold for a well to flow.

$$WGR ≡ 1.98 \times 1 {0}^{6} \frac{{k}_{rw}}{[ 2.5 \cdot {k}_{ro} + 2 \cdot {k}_{rw} ]} \cdot {GLR}^{- 1} \qquad ( 3 )$$

If there is no information of relative permeabilities, but at least one separator data at critical conditions is available for a field, then Equation 3 can be modified to group the constant and relative permeability terms and adjust the new field constant C_{field} to match the data in the GLR vs WGR log-log plot.

$$WGR = {C}_{field} \cdot {GLR}^{- 1} \qquad ( 4 )$$

GLR Vs. WGR Diagnostic Plot—Critical Water Saturation

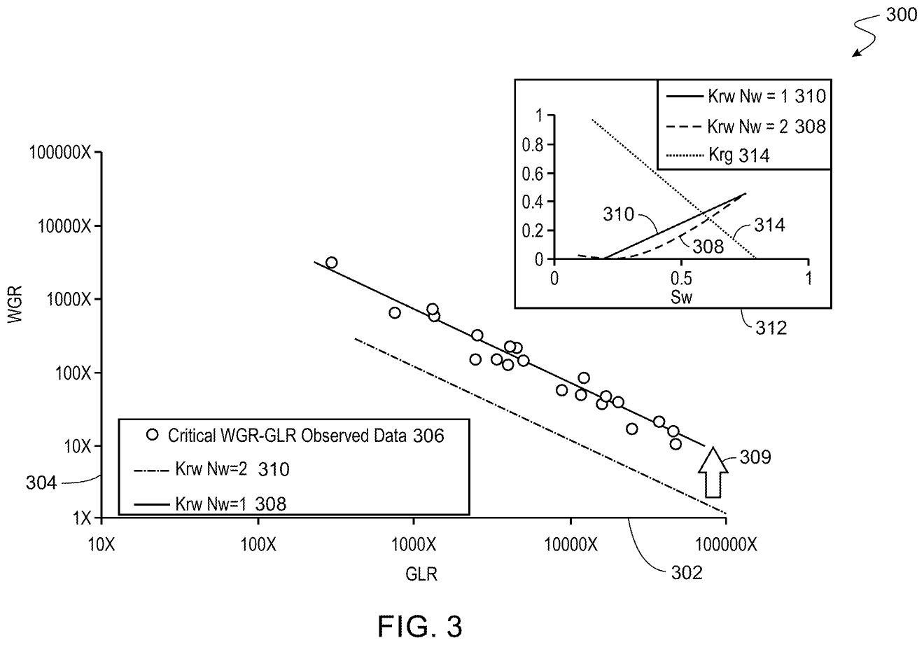

FIG. 3 is a graph 300 showing an example of a Corey Exponent of Water Relative Permeability and its impact on matching of the separator tests at critical conditions, according to some implementations of the present disclosure. FIG. 3 shows a clear dependency of K_{rw} curvature on the WGR 304 and GLR 302 match. The case that was selected uses a linear water and gas relative permeability, as it is known that the production in the selected field is affected by channeling and/or natural fractures.

The graph 300 plots points the critical WGR-GLR observed data points 306, a water relative permeability (K_{rw}) using a corey exponent (N_{w}) of 2 line 308, a K_{rw}, N_{w}=1 line 310, notice that the corey exponent is changing the shape (curvature of K_{rw}), and a shift in the 309 line is observed when the water relative permeability uses N_{w} of 2 and N_{w} of 1. A plot 312 shows the water relative permeability as explained before and also the gas relative permeability (K_{rg}) line 314. In Summary, the purpose of this graph is to show that the critical line which is part of this invention is highly related to the water relative permeability, then, the water relative permeability, line 308 is the starting point where there is no match with a value of N_{w}=2, and then by changing the N_{w} until it reaches a value of I can match the data observed in the line 309.

### GLR Versus WGR Diagnostic Plot—Oil Relative Permeability

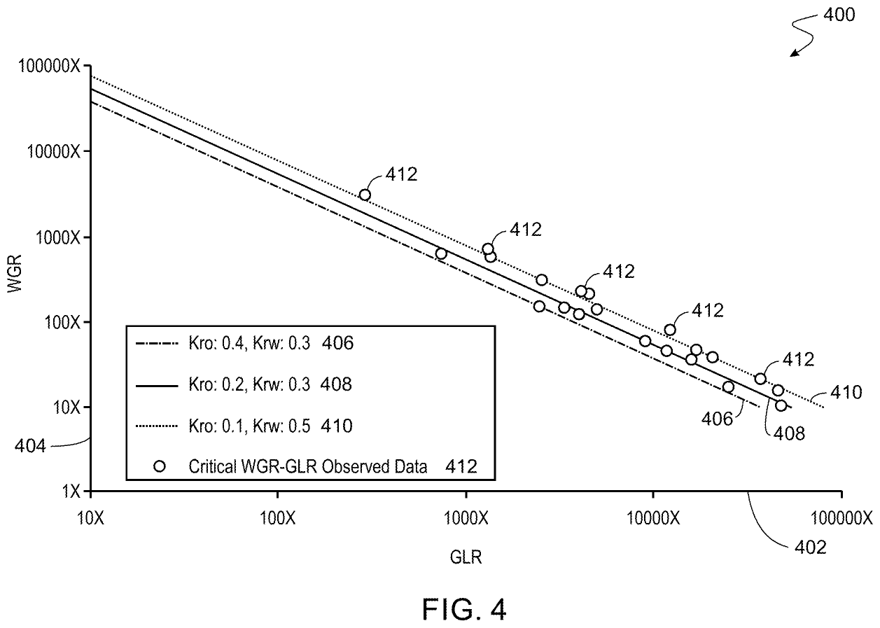

FIG. 4 is a log-log graph 400 showing an example of an Oil and Water Relative Permeability and its impact on matching of the separator tests at critical conditions, according to some implementations of the present disclosure. FIG. 4 was generated using Equation 4 at different Kᵣₒ values with a K_{rw} of 0.3 and 0.5, revealing a link between the relative permeabilities and the threshold where the critical flow starts. A value of K_{rw} of 0.3 represents the moment when the water starts to significantly impact the gas mobility (this is not an end-point). Additional sensitivities can be done for K_{rw}, residual gas saturation, gas trap saturation, gas re-mobilization, and hysteresis among other parameters, as every reservoir is unique.

The log-log graph 400 is plotted relative to GLR 402 and WGR 404. The log-log graph 400 includes a line 406 (for Kᵣₒ=0.4, K_{rw}=0.3), a line 408 (for Kᵣₒ=0.2, K_{rw}=0.3), and a line 410 (for Kᵣₒ=0.1, K_{rw}=0.5) for critical WGR-GLR observed data points 412.

The graphs of FIGS. 3 and 4 are adjustable for each specific reservoir, as the relative permeability match that is generated for this case in fact is a generic gas-water relative permeability for all the reservoirs in the plot, providing a sense of the range of relative permeabilities that the reservoirs may have.

### Application

A GLR vs. WGR diagnostic plot helps to highlight at the management level the hydrocarbon volumes at risk, to perform production screening analysis per well, and to be prepared to solve issues if any. The plots also help in understanding the link of endpoints relative to permeability curves with production data and to use them for modeling purposes.

During development and testing, the predictability of the correlation was examined and yielded a 95% efficacy with a maximum range of 4 months delay in predicting when a certain well may cease to flow due to liquid loading (e.g., from Fields A, B, C, D and E). The reason the prediction is not 100% accurate is because the separator samples that were selected do not follow a perfect line, as there is an implicit uncertainty when separator tests are selected at critical conditions (FIG. 4).

### Decline Analysis

By using both relations (GLR and WGR) at the same time, it is possible to define the decline trajectory of a well. For this case, a conventional Arps decline analysis was utilized to estimate the production forecasts of oil, gas, and water. The same forecast for each phase can be truncated when it reaches a certain GLR and WGR dictated by the critical line of the correlation.

FIG. 5 is a graph 500 showing an example of a forecast production example, according to some implementations of the present disclosure. Lines 506-514 in the graph 500 are plotted relative to GLR 502 and WGR 504. In this example, the well follows a GLR-WGR trajectory until reaching the critical unstable flow criteria. Line 506 represents a forecast using Equations 1 and 2. Triangles 510 represent a separator test. Line 508 represents an Arps decline analysis. Circles 514 are the observed data of well at critical conditions from other fields. Line 512 is a critical line. As such, FIG. 5. shows a well that has already reached the medium WGR and GLR portion of the graph and has begun to travel in the critical zone (shown by arrow 516 approximating the distribution of the triangles 510 representing the separator test). This specific well X for a field J is a natural fracture gas condensate well in blow down pending gas injection. It can be observed that the data begins to increase its WGR constantly towards the critical line with a relatively constant GLR. This is quite an atypical case where there are several separator tests which helped to clearly identify the trajectory. Line 508 comes from decline analysis which ends when it reaches the critical line of line 512. Line 506 represents a forecast match using Equations 3 and 4 with the relative permeability curves at different saturations.

During gas injection or even in blowdown scenarios, one of the objectives is to determine how the recoverable oil and the economics will be affected. By doing the same decline analysis as presented with reference to FIG. 5, analysis was done for all the wells in Field A which is a volatile oil with a gas injection in the gas condensate cap.

FIG. 6 is a graph 600 showing an example of a ranking example per well and sector for field A, according to some implementations of the present disclosure. The graph 600 shows the difference of cumulative oil production with and without applying the GLR-WGR constraint. FIG. 6 clearly shows the wells that have higher risk. The scale of the lines 604 is logarithmic and the value of X is 1. The units in line 602 are in years and the value of X is 1. Point 608 and point 610 show that the production in Sector A will be at risk after approximately 3 years of production, while Sector B (point 610) shows that it will be at risk after 3.8 years.

### Reservoir Simulation

Some selected mechanistic models were run to check the GLR-WGR critical line concept. The following example (Plot 700) shows the GLR and WGR trajectory of a simulated well with different CGR (Condensate Gas Ratio) values, showing CGR sensitivity, the lines 702 and 704 are in logarithmic scale and the value of X is 1. Points 706 show a model with a Condensate Gas Ratio (CGR) of 10 stb/MMcf, points 708 have a CGR of 50 stb/MMscf, points 710 have a CGR of 150 stb/MMscf, points 712 have a CGR of 200 stb/MMscf, and points 714 have a CGR of 250 stb/MMscf. The model has a Swr of 0.1 with 0.4 of the initial water saturation, 1 millidarcy (md) permeability, 0.1 porosity, and 50 feet net thickness. The model shows that at some point the WGR starts decreasing and GLR starts increasing, this is the point that correlates with the critical line trend, this curvature cannot be calculated with conventional decline analysis (see FIG. 5 line 506).

The well represented by graph 700 flowed for 10 years for the case with a CGR of 10 stock tank barrels per million standard cubic feet (stb/MMscf) without showing any indication of unstable flow (points 706). This was expected as the model was run without any constraints. This highlights the importance of using wellbore and reservoir CGR constraints when doing production forecasts.

FIG. 7 is a graph 700 showing an example of a reservoir simulation sensitivity at different CGR values, according to some implementations of the present disclosure. FIG. 7 also shows that at a lower CGR (higher GLR), the maximum WGR to achieve the critical line is lower than when the CGR is higher. The presence of oil increases the threshold of water production in the well. FIG. 7 shows the average critical line presented in FIG. 4, as a reference.

Points in the graph 700 are plotted relative to GLR 702 and WGR 704. The graph 700 includes CGR 10 data points 706, CGR 50 data points 708, CGR 150 data points 710, CGR 200 data points 712, CGR 250 data points 714, and a critical line 716. The graph 700 shows a horizontal line 718 above which exists 10 stbwd clear formation water. The graph 700 also shows a horizontal line 720 below which exists condensate water.

### Water Relative Permeability Curvature Sensitivity

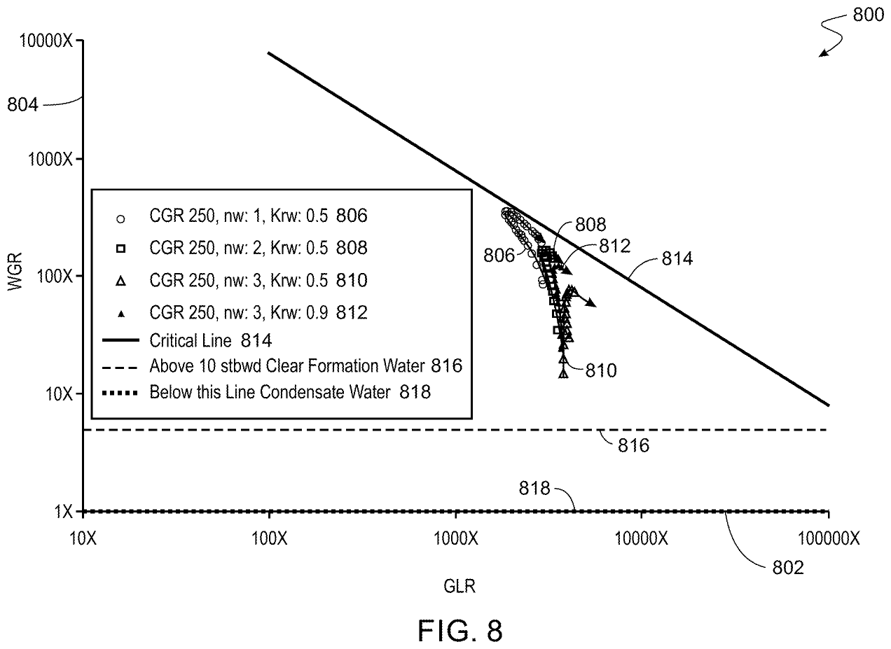

FIG. 8 is a graph 800 showing an example of a reservoir simulation sensitivity at different K_{rw} Corey Exponents, according to some implementations of the present disclosure. Specifically, FIG. 8 shows a reservoir simulation sensitivity with a K_{rw} end point of 0.5 with 3 N_{w} Corey exponent (curve 810). It can be observed in FIG. 8 that higher mobility values lead to higher WGR values producible by the well. Curve 806 with N_{w} of 1 (straight line K_{rw}) has a similar behavior to the separator test shown in FIG. 5. Additional tests were run using a K_{rw} of 0.9 and N_{w} of 3 (curve 812), showing an increase of the inflection point and having a similar behavior than K_{rw} of 0.5 and N_{w} of 2 (curve 808). Points in the graph 800 are plotted relative to GLR 802, WGR 804, and critical line 814. The graph 800 shows a horizontal line 816 above which exists 10 stbwd clear formation water. The graph 800 also shows a horizontal line 818 below which exists condensate water.

### Draw Down

By just inferring the GLR-WGR trajectory of a well using decline analysis or reservoir simulation, it is possible to define when a well can begin to experience production problems. In case the trajectory goes to the right (less water and high gas), it means that the well can have many opportunities to be reactivated by reducing the head or bottom hole pressure (e.g. installing a well pad facility (WPF), or by implementing a gas lift solution or a huff and puff process.

Note that when a well finally reaches the critical zone, it does not mean that the well will stop flowing. In fact, there is an implicit margin of error in the risk graph, which has been observed to be in a range of 1 to 4 months, where for practical purposes, a high-resolution time window exists.

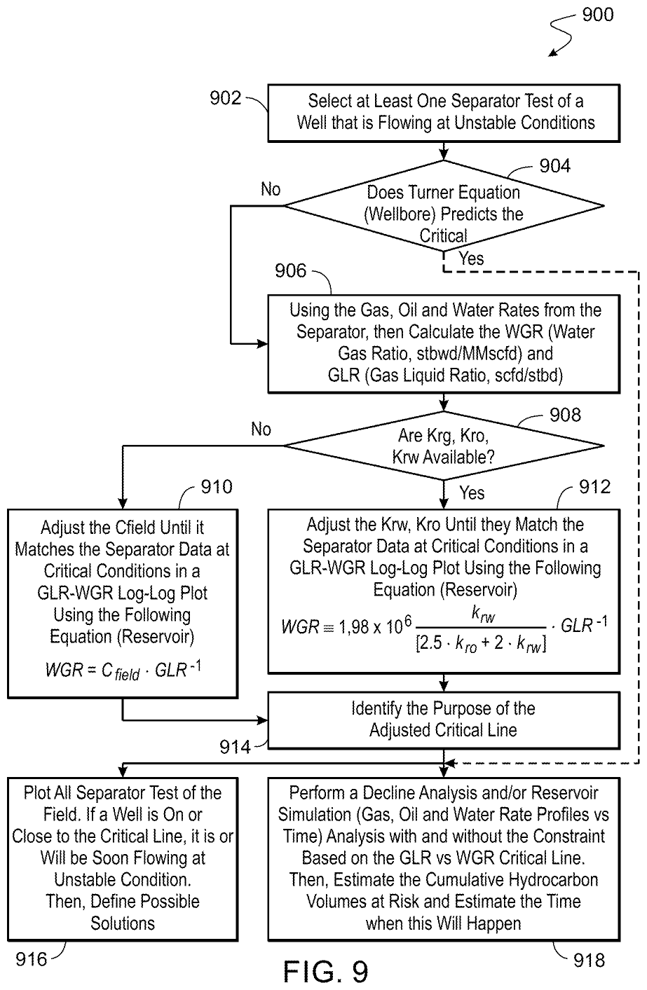

FIG. 9 is a flow chart showing an example of a workflow 900 for determining near wellbore critical gas rate correlations for oil and gas reservoirs, according to some implementations of the present disclosure.

At 902, at least one separator test is selected for a well that is flowing at unstable conditions. At 904, a determination is made whether Turner's equation predicts the critical line.

At 906, gas, oil, and water rates from the separator are used to calculate the WGR (e.g., in stbwd/MMscfd) and GLR (e.g., in scfd/stbd). At 908, a determination is made whether K_{rg}, Kᵣₒ, and K_{rw} are available.

At 910, the C_{field} is adjusted using Equation 4 until it matches the separator data at critical conditions in a GLR-WGR log-log plot. At 912, the K_{rw} and Kᵣₒ are adjusted using Equation 3 until they match the separator data at critical conditions in a GLR-WGR log-log plot.

At 914, the purpose of the adjusted critical line is identified. At 916, all separator tests of the field are plotted. If a well is on or close to the critical line, the well is or will be soon flowing at unstable conditions. Then, possible solutions are defined.

At 918, a decline analysis and/or reservoir simulation (gas, oil, and water rate profiles vs time) analysis are performed with and without the constraint based on the GLR vs WGR critical line. Then, the cumulative hydrocarbon volumes at risk are estimated, and the time when this will happen is also estimated.

### SUMMARY

For sandstone gas condensate/volatile oil reservoirs in blow down and gas injection and gas condensate carbonate reservoirs, it was found that a power law correlation of GLR vs WGR fits the wells with unstable production. The correlation can be generated by just fitting the observed data or by using Darcy's Law.

Defining the constraints for the production of oil and gas forecasts can highly impact reservoir management efficiency. The correlation is an approximation that up to date has been proven to have a high probability of efficacy (>95%) determining the moment when a well will be flowing in unstable conditions.

In some implementations, more information can be collected to extend this analysis to other hydrocarbon fluid and reservoir systems and injection schemes. Also, additional reservoir simulation sensitivities can be performed including the non-Darcy skin, and finally include this constraint in analytical and reservoir simulation models.

### Assumptions

The objective of this section is to show the assumptions made to obtain Equations 1 and 2, which are based on some approximations. It is possible to obtain more rigorous expressions that include pseudo pressures and avoid general values assumed for temperature and z factor for the gas.

### Darcy's Law

As the main objective is to understand the WGR, GLR, and GOR just before the well stops flow, Darcy's Law was used for Equations 3 to 6, which are the solutions of the Darcy equations for oil, water, and gas.

$${q}_{o} = \frac{{k}_{ro} kh ( {p}_{r} - {p}_{wf} )}{141.2 {μ}_{o} {B}_{o} [ ln ( {r}_{e} / {r}_{w} ) - 0.75 + s ]} \qquad A \text{.1}$$

$${q}_{w} = \frac{{k}_{rw} kh ( {p}_{r} - {p}_{wf} )}{141.2 {μ}_{w} {B}_{w} [ ln ( {r}_{e} / {r}_{w} ) - 0.75 + s ]} \qquad A \text{.2}$$

For low pressures (e.g., lower than 2000 pounds per square inch (psi)):

$${q}_{g} = \frac{0.7 \; 03 {k}_{rg} kh ( {p}_{r}^{2} - {p}_{wf}^{2} )}{T {μ}_{g} z [ ln ( {r}_{e} / {r}_{w} ) - 0.75 + s + {Dq}_{g} ]} \qquad A \text{.3}$$

where q_{g} is in scfd, k is in md, h is in feet, T is in Rankin, μ is in cp, D is in 1/MMscfd, rₑ is in ft, r_{w} is in ft, and s the skin is adimensional.

$$A = ln ( {r}_{e} / {r}_{w} ) - 0.75 + s + {Dq}_{g} \qquad A \text{.4}$$

$$B = ln ( {r}_{e} / {r}_{w} ) - 0.75 + s \qquad A \text{.5}$$

For high pressures (e.g., greater than 3000 psi), the following equation can be used. While a good approach may be to use the pseudo-pressure approach, for the sake of simplicity this equation can be used:

$${q}_{g} = \frac{1.4 \; 06 {k}_{rg} kh ( p / {μ}_{g} z ) ( {p}_{r} - {p}_{wf} )}{T [ ln ( {r}_{e} / {r}_{w} ) - 0.75 + s + {Dq}_{g} ]} \qquad A \text{.6}$$

### Gas Liquid Ratio (GLR)

For low pressures, Equation A.6, Equation A.1 and A.2 are used to get GLR:

$$GLR = \frac{\frac{0.703 {k}_{rg} ( {p}_{r}^{2} - {p}_{wf}^{2} )}{T {μ}_{g} z \cdot A}}{[ \frac{{k}_{ro} ( {p}_{r} - {p}_{wf} )}{141.2 {μ}_{o} {B}_{o}} + \frac{{k}_{rw} ( {p}_{r} - {p}_{wf} )}{141.2 {μ}_{w} {B}_{w}} ] \cdot \frac{1}{B}} \qquad A \text{.7}$$

Using the identity (a²−b²)=(a+b)(a−b) in Equation A.7:

$$GLR = \frac{\frac{0.703 {k}_{rg} ( {p}_{r} - {p}_{wf} ) ( {p}_{r} + {p}_{wf} )}{T {μ}_{g} z \cdot A}}{[ \frac{{k}_{ro} ( {p}_{r} - {p}_{wf} )}{141.2 {μ}_{o} {B}_{o}} + \frac{{k}_{rw} ( {p}_{r} - {p}_{wf} )}{141.2 {μ}_{w} {B}_{w}} ] \cdot \frac{1}{B}} \qquad A \text{.8}$$

### Reorganizing Equation A.8:

$$GLR = \frac{1}{0.7 \; 03 \cdot 14 \; 1.2} \cdot \frac{B}{A} \cdot \frac{\frac{{k}_{rg} ( {p}_{r} + {p}_{wf} )}{T {μ}_{g} z}}{[ \frac{{k}_{ro}}{{μ}_{o} {B}_{o}} + \frac{{k}_{rw}}{{μ}_{w} {B}_{w}} ]} \qquad A \text{.9}$$

The average pressure is given by Equation A.10.

$${p}_{av} = \overline{p} = \frac{( {p}_{r} + {p}_{wf} )}{2} \qquad A \text{.10}$$

The general WGR equation for high pressure is as follows:

$$GLR ≡ 99.2 \; 636 \cdot \frac{B}{A} \cdot \frac{2 \overline{p}}{T {μ}_{g} z} \cdot \frac{{k}_{rg}}{[ \frac{{k}_{ro}}{{μ}_{o} {B}_{o}} + \frac{{k}_{rw}}{{μ}_{w} {B}_{w}} ]} \qquad A \text{.11}$$

Assuming A/B=1 (not considering the non-Darcy skin), and re-writing the Equation A.11. The general GLR equation for low pressure is:

$$GLR ≡ ( 100 \cdot 2 ) \cdot \frac{\overline{p}}{T {μ}_{g} z} \frac{{k}_{rg}}{[ \frac{{k}_{ro}}{{μ}_{o} {B}_{o}} + \frac{{k}_{rw}}{{μ}_{w} {B}_{w}} ]} \qquad A \text{.12}$$

Replacing the values with some generic values (B_{w}=1 rb/stb, Bₒ=2 rb/stb, μ_{w}=0.5, reservoir Temp: 250 F, μ_{g}=0.02 cp, μₒ=0.2 cp, and z=1) for the fields A, B, C, D, E, F, G, H and I:

$$G L R ≡ 200 \cdot \frac{\overline{p}}{( 250 + 4 \; 60 ) \cdot 0.02 \cdot 1} \cdot \frac{{k}_{rg}}{[ \frac{{k}_{ro}}{0.2 \cdot 2} + \frac{{k}_{rw}}{0.5 \cdot 1} ]} \qquad A \text{.13}$$

The Final simplified equation for GLR for low pressure is as follows:

$$G L R ≡ 7 \cdot \overline{p} \cdot \frac{{k}_{rg}}{( 2.5 \cdot {k}_{ro} + 2 \cdot {k}_{rw} )} \qquad A \text{.14}$$

For High Pressure, Equation A.6, Equation A.1 and A.6 can be used to get GLR.

$$G L R = \frac{\frac{1.406 {k}_{rg} kh ( p / {μ}_{g} z ) ( {p}_{r} - {p}_{w f} )}{T \cdot A}}{[ \frac{{k}_{ro} ( {p}_{r} - {p}_{w f} )}{141.2 {μ}_{o} {B}_{o}} + \frac{{k}_{rw} ( {p}_{r} - {p}_{w f} )}{141.2 {μ}_{w} {B}_{w}} ] \cdot \frac{1}{B}} \qquad A \text{.15}$$

The general GLR equation for high pressure is:

$$G L R = 198.5 \; 272 \cdot \frac{B}{A} \cdot \frac{p}{T {μ}_{g} z} \frac{{k}_{rg}}{[ \frac{{k}_{ro}}{{μ}_{o} {B}_{o}} + \frac{{k}_{rw}}{{μ}_{w} {B}_{w}} ]} \qquad A \text{.16}$$

Replacing the values with some generic values (B_{w}=1 rb/stb, Bₒ=2 rb/stb, μ_{w}=0.5, reservoir Temp: 250 F, μ_{g}=0.02 cp, μₒ=0.2 cp, and z=1) for the fields A, B, C, D, G, H D (refer to FIG. 2).

$$G L R ≡ 200 \cdot 1 \cdot \frac{p}{( 250 + 4 \; 60 ) \cdot 0.02 \cdot 1} \frac{{k}_{rg}}{[ \frac{{k}_{ro}}{0.2 \cdot 2} + \frac{{k}_{rw}}{0.5 \cdot 1} ]} \qquad A \text{.17}$$

$$GLR ≡ 200 \cdot 1 \cdot \frac{p}{14.2} \frac{{k}_{rg}}{[ 2.5 \cdot {k}_{ro} + 2 \cdot {k}_{rw} ]} \qquad A \text{.18}$$

The Final simplified equation for GLR for high pressure is as follows:

$$G L R ≡ 14 \cdot p \cdot \frac{{k}_{rg}}{[ 2.5 \cdot {k}_{ro} + 2 \cdot {k}_{rw} ]} \qquad A \text{.19}$$

### Water Gas Ratio (WGR)

For low pressure, following the same procedure used to get the GLR Equation, it is possible to get the WGR Equation:

$$WGR = \frac{\frac{{k}_{rw}}{141.2 {μ}_{w} {B}_{w} \cdot B}}{\frac{0.7 \; 03 {k}_{rg} ( {p}_{r} + {p}_{wf} )}{T {μ}_{g} z \cdot A}} \qquad A \text{.20}$$

Reorganizing the Equation A.20 and approximating the constant of 200.853 to 200, then

$$WGR ≡ \frac{1}{200} \cdot \frac{A}{B} \cdot \frac{T {μ}_{g} z}{{μ}_{w} {B}_{w}} \cdot \frac{1}{( {p}_{r} + {p}_{w f} )} \frac{{k}_{rw}}{{k}_{rg}} \qquad A \text{.21}$$

Using the average pressure Equation A.10. The general WGR equation for high pressure is as follows:

$$WGR ≡ \frac{1}{200} \frac{A}{B} \frac{T {μ}_{g} z}{{μ}_{w} {B}_{w}} \frac{1}{2 \overline{p}} \frac{{k}_{rw}}{{k}_{rg}} \qquad A \text{.22}$$

Replacing the values with some generic values (B_{w}=1 rb/stb, μ_{w}=0.5 cp, reservoir Temp 250 F, μ_{g}=0.02 cp, and z=1) and assuming A/B=1 (not considering the non-Darcy skin) for the fields A, B, C, D, E, F, G, H and I:

$$WGR ≡ \frac{1}{200} \frac{0 \text{.02} \cdot ( 250 + 4 \; 60 ) \cdot 1}{0.5 \cdot 1} \cdot 1 \cdot \frac{1}{2 \overline{p}} \frac{{k}_{rw}}{{k}_{rg}} \qquad A \text{.23}$$

$$WGR ( stbw / scf ) ≡ 0.071 \frac{1}{2 \overline{p}} \frac{{k}_{rw}}{{k}_{rg}} \qquad A \text{.24}$$

The final simplified equation for WGR for low pressure is as follows:

$$WGR ( stbw / MMscf ) ≡ 35 , 000 \frac{1}{\overline{p}} \frac{{k}_{rw}}{{k}_{rg}} \qquad A \text{.25}$$

For high pressure:

$$WGR = \frac{\frac{{k}_{rw} k h}{141.2 {μ}_{w} {B}_{w} \cdot B}}{\frac{1.406 {k}_{rg} kh ( p / {μ}_{g} z )}{T \cdot A}} \qquad A \text{.26}$$

$$WGR = \frac{1}{198.5272} \frac{A}{B} \frac{{μ}_{g} Tz}{p} \frac{1}{{μ}_{w} {B}_{w}} \frac{{k}_{rw}}{{k}_{rg}} \qquad A \text{.27}$$

Replacing the values with some standard values (B_{w}=1 rb/stb, μ_{w}=0.5 cp, reservoir Temp for this case 250 F, μ_{g}=0.02 cp, and z=1) and assuming A/B=1 (not considering the non-Darcy skin) for fields A, B, C, D, E, F, G, H and I (refer to FIG. 2).

$$W G R ≡ \frac{1}{200} \cdot 1 \cdot \frac{0 \text{.02} \cdot ( 250 + 4 \; 60 ) \cdot 1}{p} \frac{1}{0.5 \cdot 1} \frac{{k}_{rw}}{{k}_{rg}} \qquad A \text{.28}$$

$$WGR ( s tbw / scf ) ≡ 0.1 \; 42 \cdot \frac{1}{p} \cdot \frac{{k}_{rw}}{{k}_{rg}} \qquad A \text{.29}$$

Updating the units of WGR for stbwd/MMscfd, then:

$$W G R ( s tbw / MMscf ) ≡ 142 , 000 \cdot \frac{1}{p} \cdot \frac{{k}_{rw}}{{k}_{rg}} \qquad A \text{.30}$$

### Water Gas Ratio (WGR) and Gas Liquid Ratio (GLR)

For low pressure, using the Equation A.2 and Equation A.3 obtain WGR.

$$WGR ≡ 35 , 000 \cdot \frac{1}{\frac{( 2.5 \cdot {k}_{ro} + 2 {k}_{rw} )}{7 \cdot {k}_{rg}}} \frac{{k}_{rw}}{{k}_{rg}} GL {R}^{- 1} \qquad A \text{.31}$$

Equation A.33 is the simplified equation that represents the trajectory of the GLR and WGR for low pressure systems.

$$WGR ≡ 245 , 000 \frac{{k}_{rw}}{( 2.5 \cdot {k}_{ro} + 2 {k}_{rw} )} {GLR}^{- 1} \qquad A \text{.32}$$

For high pressure, using the Equation A.2 and Equation A.6 obtain WGR.

$$WGR ≡ 142 , 000 \cdot \frac{1}{GLR \cdot \frac{[ 2.5 \cdot {k}_{ro} + 2 \cdot {k}_{rw} ]}{14 * {k}_{rg}}} \cdot \frac{{k}_{rw}}{{k}_{rg}} \qquad A \text{.33}$$

Equation A.36 is the simplified equation that represents the trajectory of the GLR and WGR, for fields A, B, C, D, E, F, G, H, and I (refer to FIG. 2).

$$WGR ≡ 1988000 \frac{{k}_{rw}}{[ 2.5 \cdot {k}_{ro} + 2 \cdot {k}_{rw} ]} \cdot {GLR}^{- 1} \qquad A \text{.34}$$

$$WGR ≡ 1 , 98 \times {10}^{6} \frac{{k}_{rw}}{[ 2.5 \cdot {k}_{ro} + 2 \cdot {k}_{rw} ]} \cdot {GLR}^{- 1} \qquad A \text{.35}$$

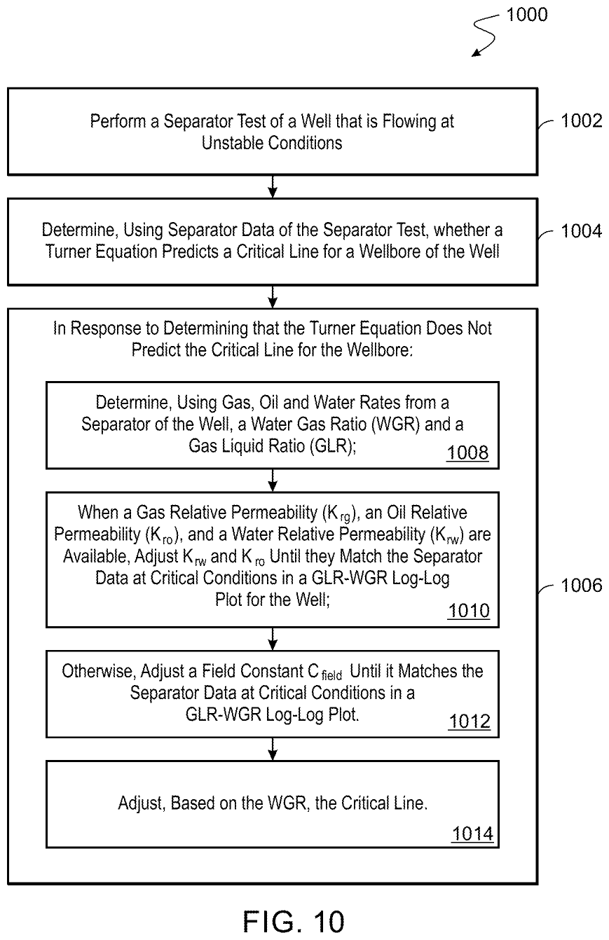

FIG. 10 is a flowchart of an example of a method 1000 for determining near wellbore critical gas rate correlations for oil and gas reservoirs, according to some implementations of the present disclosure. For clarity of presentation, the description that follows generally describes method 1000 in the context of the other figures in this description. However, it will be understood that method 1000 can be performed, for example, by any suitable system, environment, software, and hardware, or a combination of systems, environments, software, and hardware, as appropriate. In some implementations, various steps of method 1000 can be run in parallel, in combination, in loops, or in any order.

At 1002, a separator test is performed for a well that is flowing at unstable conditions. From 1002, method 1000 proceeds to 1004.

At 1004, a determination is made, using separator data of the separator test, whether a Turner equation predicts a critical line for a wellbore of the well. From 1004, method 1000 proceeds to 1006.

At 1006, in response to determining that the Turner Equation does not predict the critical line for the wellbore. Step 1006 includes steps 1008 through 1014.

At 1008, a WGR and a GLR are determined using gas, oil, and water rates from a separator of the well. From 1008, method 1000 proceeds to 1010.

At 1010, when a gas relative permeability (K_{rg}), an oil relative permeability (Kᵣₒ), and a water relative permeability (K_{rw}) are available, K_{rw} and Kᵣₒ are adjusted until they match the separator data at critical conditions in a GLR-WGR log-log plot for the well. From 1010, method 1000 proceeds to 1012.

At 1012, otherwise, a field constant C_{field} is adjusted until it matches the separator data at critical conditions in a GLR-WGR log-log plot. From 1012, method 1000 proceeds to 1014.

At 1014, the critical line is adjusted based on the WGR. After 1014, method 1000 can stop.

In some implementations, in addition to (or in combination with) any previously-described features, techniques of the present disclosure can include the following. Outputs of the techniques of the present disclosure can be performed before, during, or in combination with wellbore operations, such as to provide inputs to change the settings or parameters of equipment used for drilling. Examples of wellbore operations include forming/drilling a wellbore, hydraulic fracturing, and producing through the wellbore, to name a few. The wellbore operations can be triggered or controlled, for example, by outputs of the methods of the present disclosure. In some implementations, customized user interfaces can present intermediate or final results of the above described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or “app”), or at a central processing facility. The presented information can include suggestions, such as suggested changes in parameters or processing inputs, that the user can select to implement improvements in a production environment, such as in the exploration, production, and/or testing of petrochemical processes or facilities. For example, the suggestions can include parameters that, when selected by the user, can cause a change to, or an improvement in, drilling parameters (including drill bit speed and direction) or overall production of a gas or oil well. The suggestions, when implemented by the user, can improve the speed and accuracy of calculations, streamline processes, improve models, and solve problems related to efficiency, performance, safety, reliability, costs, downtime, and the need for human interaction. In some implementations, the suggestions can be implemented in real-time, such as to provide an immediate or near-immediate change in operations or in a model. The term real-time can correspond, for example, to events that occur within a specified period of time, such as within one minute or within one second. Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

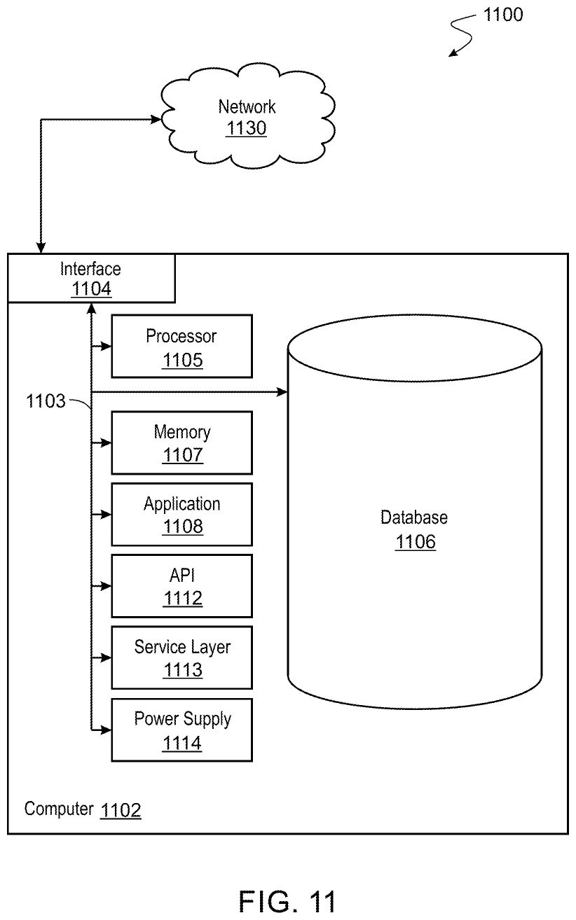

FIG. 11 is a block diagram of an example computer system 1100 used to provide computational functionalities associated with described algorithms, methods, functions, processes, flows, and procedures described in the present disclosure, according to some implementations of the present disclosure. The illustrated computer 1102 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 1102 can include input devices such as keypads, keyboards, and touch screens that can accept user information. Also, the computer 1102 can include output devices that can convey information associated with the operation of the computer 1102. The information can include digital data, visual data, audio information, or a combination of information. The information can be presented in a graphical user interface (UI) (or GUI).

The computer 1102 can serve in a role as a client, a network component, a server, a database, a persistency, or components of a computer system for performing the subject matter described in the present disclosure. The illustrated computer 1102 is communicably coupled with a network 1130. In some implementations, one or more components of the computer 1102 can be configured to operate within different environments, including cloud-computing-based environments, local environments, global environments, and combinations of environments.

At a top level, the computer 1102 is an electronic computing device operable to receive, transmit, process, store, and manage data and information associated with the described subject matter. According to some implementations, the computer 1102 can also include, or be communicably coupled with, an application server, an email server, a web server, a caching server, a streaming data server, or a combination of servers.

The computer 1102 can receive requests over network 1130 from a client application (for example, executing on another computer 1102). The computer 1102 can respond to the received requests by processing the received requests using software applications. Requests can also be sent to the computer 1102 from internal users (for example, from a command console), external (or third) parties, automated applications, entities, individuals, systems, and computers.

Each of the components of the computer 1102 can communicate using a system bus 1103. In some implementations, any or all of the components of the computer 1102, including hardware or software components, can interface with each other or the interface 1104 (or a combination of both) over the system bus 1103. Interfaces can use an application programming interface (API) 1112, a service layer 1113, or a combination of the API 1112 and service layer 1113. The API 1112 can include specifications for routines, data structures, and object classes. The API 1112 can be either computer-language independent or dependent. The API 1112 can refer to a complete interface, a single function, or a set of APIs.

The service layer 1113 can provide software services to the computer 1102 and other components (whether illustrated or not) that are communicably coupled to the computer 1102. The functionality of the computer 1102 can be accessible for all service consumers using this service layer. Software services, such as those provided by the service layer 1113, can provide reusable, defined functionalities through a defined interface. For example, the interface can be software written in JAVA, C++, or a language providing data in extensible markup language (XML) format. While illustrated as an integrated component of the computer 1102, in alternative implementations, the API 1112 or the service layer 1113 can be stand-alone components in relation to other components of the computer 1102 and other components communicably coupled to the computer 1102. Moreover, any or all parts of the API 1112 or the service layer 1113 can be implemented as child or sub-modules of another software module, enterprise application, or hardware module without departing from the scope of the present disclosure.

The computer 1102 includes an interface 1104. Although illustrated as a single interface 1104 in FIG. 11, two or more interfaces 1104 can be used according to particular needs, desires, or particular implementations of the computer 1102 and the described functionality. The interface 1104 can be used by the computer 1102 for communicating with other systems that are connected to the network 1130 (whether illustrated or not) in a distributed environment. Generally, the interface 1104 can include, or be implemented using, logic encoded in software or hardware (or a combination of software and hardware) operable to communicate with the network 1130. More specifically, the interface 1104 can include software supporting one or more communication protocols associated with communications. As such, the network 1130 or the interface's hardware can be operable to communicate physical signals within and outside of the illustrated computer 1102.

The computer 1102 includes a processor 1105. Although illustrated as a single processor 1105 in FIG. 11, two or more processors 1105 can be used according to particular needs, desires, or particular implementations of the computer 1102 and the described functionality. Generally, the processor 1105 can execute instructions and can manipulate data to perform the operations of the computer 1102, including operations using algorithms, methods, functions, processes, flows, and procedures as described in the present disclosure.

The computer 1102 also includes a database 1106 that can hold data for the computer 1102 and other components connected to the network 1130 (whether illustrated or not). For example, database 1106 can be an in-memory, conventional, or a database storing data consistent with the present disclosure. In some implementations, database 1106 can be a combination of two or more different database types (for example, hybrid in-memory and conventional databases) according to particular needs, desires, or particular implementations of the computer 1102 and the described functionality. Although illustrated as a single database 1106 in FIG. 11, two or more databases (of the same, different, or combination of types) can be used according to particular needs, desires, or particular implementations of the computer 1102 and the described functionality. While database 1106 is illustrated as an internal component of the computer 1102, in alternative implementations, database 1106 can be external to the computer 1102.

The computer 1102 also includes a memory 1107 that can hold data for the computer 1102 or a combination of components connected to the network 1130 (whether illustrated or not). Memory 1107 can store any data consistent with the present disclosure. In some implementations, memory 1107 can be a combination of two or more different types of memory (for example, a combination of semiconductor and magnetic storage) according to particular needs, desires, or particular implementations of the computer 1102 and the described functionality. Although illustrated as a single memory 1107 in FIG. 11, two or more memories 1107 (of the same, different, or combination of types) can be used according to particular needs, desires, or particular implementations of the computer 1102 and the described functionality. While memory 1107 is illustrated as an internal component of the computer 1102, in alternative implementations, memory 1107 can be external to the computer 1102.

The application 1108 can be an algorithmic software engine providing functionality according to particular needs, desires, or particular implementations of the computer 1102 and the described functionality. For example, application 1108 can serve as one or more components, modules, or applications. Further, although illustrated as a single application 1108, the application 1108 can be implemented as multiple applications 1108 on the computer 1102. In addition, although illustrated as internal to the computer 1102, in alternative implementations, the application 1108 can be external to the computer 1102.

The computer 1102 can also include a power supply 1114. The power supply 1114 can include a rechargeable or non-rechargeable battery that can be configured to be either user- or non-user-replaceable. In some implementations, the power supply 1114 can include power-conversion and management circuits, including recharging, standby, and power management functionalities. In some implementations, the power supply 1114 can include a power plug to allow the computer 1102 to be plugged into a wall socket or a power source to, for example, power the computer 1102 or recharge a rechargeable battery.

There can be any number of computers 1102 associated with, or external to, a computer system containing computer 1102, with each computer 1102 communicating over network 1130. Further, the terms “client,” “user,” and other appropriate terminology can be used interchangeably, as appropriate, without departing from the scope of the present disclosure. Moreover, the present disclosure contemplates that many users can use one computer 1102 and one user can use multiple computers 1102.

Described implementations of the subject matter can include one or more features, alone or in combination.

For example, in a first implementation, a computer-implemented method includes the following. A separator test is performed for a well that is flowing at unstable conditions. A determination is made, using separator data of the separator test, whether a Turner equation predicts a critical line for a wellbore of the well. In response to determining that the Turner Equation does not predict the critical line for the wellbore, a water gas ratio (WGR) and a gas liquid ratio (GLR) are determined using gas, oil, and water rates from a separator of the well. When a gas relative permeability (K_{rg}), an oil relative permeability (Kᵣₒ), and a water relative permeability (K_{rw}) are available, K_{rw} and Kᵣₒ are adjusted until they match the separator data at critical conditions in a GLR-WGR log-log plot for the well. Otherwise, a field constant C_{field} is adjusted until it matches the separator data at critical conditions in a GLR-WGR log-log plot. The critical line is adjusted based on the WGR.

The foregoing and other described implementations can each, optionally, include one or more of the following features:

A first feature, combinable with any of the following features, where adjusting the K_{rw} and Kᵣₒ includes using an equation:

$$WGR ≡ 1 , 98 \times {10}^{6} \frac{{k}_{rw}}{[ 2.5 \cdot {k}_{ro} + 2 \cdot {k}_{rw} ]} \cdot {GLR}^{- 1}$$

A second feature, combinable with any of the previous or following features, where adjusting C_{field} includes using an equation:

$$WGR = {C}_{field} \cdot {GLR}^{- 1}$$

A third feature, combinable with any of the previous or following features, where the method further includes generating the GLR-WGR log-log plot for the well.

A fourth feature, combinable with any of the previous or following features, where the method further includes: plotting results of the separator test for a field containing the well and defining possible solutions.

A fifth feature, combinable with any of the previous or following features, where the method further includes performing one or both of a decline analysis and a reservoir simulation analysis with and without GLR-WGR constraints for the critical line, estimating cumulative hydrocarbon volumes at risk, and estimating a time when this will happen.

A sixth feature, combinable with any of the previous or following features, where performing the reservoir simulation analysis includes analyzing gas, oil, and water rate profiles versus time.

In a second implementation, a non-transitory, computer-readable medium stores one or more instructions executable by a computer system to perform operations including the following. A separator test is performed for a well that is flowing at unstable conditions. A determination is made, using separator data of the separator test, whether a Turner equation predicts a critical line for a wellbore of the well. In response to determining that the Turner Equation does not predict the critical line for the wellbore, a water gas ratio (WGR) and a gas liquid ratio (GLR) are determined using gas, oil, and water rates from a separator of the well. When a gas relative permeability (K_{rg}), an oil relative permeability (Kᵣₒ), and a water relative permeability (K_{rw}) are available, K_{rw} and Kᵣₒ are adjusted until they match the separator data at critical conditions in a GLR-WGR log-log plot for the well. Otherwise, a field constant C_{field} is adjusted until it matches the separator data at critical conditions in a GLR-WGR log-log plot. The critical line is adjusted based on the WGR.

The foregoing and other described implementations can each, optionally, include one or more of the following features:

A first feature, combinable with any of the following features, where adjusting the K_{rw} and Kᵣₒ includes using an equation:

$$WGR ≡ 1 , 98 \times {10}^{6} \frac{{k}_{rw}}{[ 2.5 \cdot {k}_{ro} + 2 \cdot {k}_{rw} ]} \cdot {GLR}^{- 1}$$

A second feature, combinable with any of the previous or following features, where adjusting C_{field} includes using an equation:

$$WGR = {C}_{field} \cdot {GLR}^{- 1}$$

A third feature, combinable with any of the previous or following features, where the operations further include generating the GLR-WGR log-log plot for the well.

A fourth feature, combinable with any of the previous or following features, where the operations further include: plotting results of the separator test for a field containing the well and defining possible solutions.

A fifth feature, combinable with any of the previous or following features, where the operations further include performing one or both of a decline analysis and a reservoir simulation analysis with and without GLR-WGR constraints for the critical line, estimating cumulative hydrocarbon volumes at risk, and estimating a time when this will happen.

A sixth feature, combinable with any of the previous or following features, where performing the reservoir simulation analysis includes analyzing gas, oil, and water rate profiles versus time.

In a third implementation, a computer-implemented system includes one or more processors and a non-transitory computer-readable storage medium coupled to the one or more processors and storing programming instructions for execution by the one or more processors. The programming instructions instruct the one or more processors to perform operations including the following. A separator test is performed for a well that is flowing at unstable conditions. A determination is made, using separator data of the separator test, whether a Turner equation predicts a critical line for a wellbore of the well. In response to determining that the Turner Equation does not predict the critical line for the wellbore, a water gas ratio (WGR) and a gas liquid ratio (GLR) are determined using gas, oil, and water rates from a separator of the well. When a gas relative permeability (K_{rg}), an oil relative permeability (Kᵣₒ), and a water relative permeability (K_{rw}) are available, K_{rw} and Kᵣₒ are adjusted until they match the separator data at critical conditions in a GLR-WGR log-log plot for the well. Otherwise, a field constant C_{field} is adjusted until it matches the separator data at critical conditions in a GLR-WGR log-log plot. The critical line is adjusted based on the WGR.

The foregoing and other described implementations can each, optionally, include one or more of the following features:

A first feature, combinable with any of the following features, where adjusting the K_{rw} and Kᵣₒ includes using an equation:

$$WGR ≡ 1 , 98 \times {10}^{6} \frac{{k}_{rw}}{[ 2.5 \cdot {k}_{ro} + 2 \cdot {k}_{rw} ]} \cdot {GLR}^{- 1}$$

A second feature, combinable with any of the previous or following features, where adjusting C_{field} includes using an equation:

$$WGR = {C}_{field} \cdot {GLR}^{- 1}$$

A third feature, combinable with any of the previous or following features, where the operations further include generating the GLR-WGR log-log plot for the well.

A fourth feature, combinable with any of the previous or following features, where the operations further include: plotting results of the separator test for a field containing the well and defining possible solutions.

A fifth feature, combinable with any of the previous or following features, where the operations further include performing one or both of a decline analysis and a reservoir simulation analysis with and without GLR-WGR constraints for the critical line, estimating cumulative hydrocarbon volumes at risk, and estimating a time when this will happen.

A sixth feature, combinable with any of the previous or following features, where performing the reservoir simulation analysis includes analyzing gas, oil, and water rate profiles versus time.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. For example, the signal can be a machine-generated electrical, optical, or electromagnetic signal that is generated to encode information for transmission to a suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatuses, devices, and machines for processing data, including by way of example, a programmable processor, a computer, or multiple processors or computers. The apparatus can also include special purpose logic circuitry including, for example, a central processing unit (CPU), a field-programmable gate array (FPGA), or an application-specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, such as LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub-programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory.

Graphics processing units (GPUs) can also be used in combination with CPUs. The GPUs can provide specialized processing that occurs in parallel to processing performed by CPUs. The specialized processing can include artificial intelligence (AI) applications and processing, for example. GPUs can be used in GPU clusters or in multi-GPU computing.

A computer can include, or be operatively coupled to, one or more mass storage devices for storing data. In some implementations, a computer can receive data from, and transfer data to, the mass storage devices including, for example, magnetic, magneto-optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer-readable media (transitory or non-transitory, as appropriate) suitable for storing computer program instructions and data can include all forms of permanent/non-permanent and volatile/non-volatile memory, media, and memory devices. Computer-readable media can include, for example, semiconductor memory devices such as random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer-readable media can also include, for example, magnetic devices such as tape, cartridges, cassettes, and internal/removable disks. Computer-readable media can also include magneto-optical disks and optical memory devices and technologies including, for example, digital video disc (DVD), CD-ROM, DVD+/-R, DVD-RAM, DVD-ROM, HD-DVD, and BLU-RAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated into, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that the user uses. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch-screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at the application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations. It should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

What is claimed is:

1. A computer-implemented method, comprising:
performing a separator test of a well that is flowing at unstable conditions;
determining, using separator data of the separator test, whether a Turner equation predicts a critical line for a wellbore of the well; and
in response to determining that the Turner Equation does not predict the critical line for the wellbore:
determining, using gas, oil, and water rates from a separator of the well, a water gas ratio (WGR) and a gas liquid ratio (GLR);
when a gas relative permeability (K_{rg}), an oil relative permeability (Kᵣₒ), and a water relative permeability (K_{rw}) are available, adjusting K_{rw} and Kᵣₒ until they match the separator data at critical conditions in a GLR-WGR log-log plot for the well;
otherwise, adjusting a field constant C_{field} until it matches the separator data at critical conditions in a GLR-WGR log-log plot; and
adjusting, based on the WGR, the critical line.

2. The computer-implemented method of claim 1, wherein adjusting the K_{rw} and Kᵣₒ includes using an equation:
$$WGR ≡ 1 , 98 \times {10}^{6} \frac{{k}_{rw}}{[ 2.5 \cdot {k}_{ro} + 2 \cdot {k}_{rw} ]} \cdot {GLR}^{- 1}$$

3. The computer-implemented method of claim 1, wherein adjusting C_{field} includes using an equation:
$$WGR = {C}_{field} \cdot {GLR}^{- 1}$$

4. The computer-implemented method of claim 1, the operations further comprising generating the GLR-WGR log-log plot for the well.

5. The computer-implemented method of claim 1, the operations further comprising:
plotting results of the separator test for a field containing the well; and
defining possible solutions.

6. The computer-implemented method of claim 1, the operations further comprising:
performing one or both of a decline analysis and a reservoir simulation analysis with and without GLR-WGR constraints for the critical line, estimating cumulative hydrocarbon volumes at risk, and estimating a time when this will happen.

7. The computer-implemented method of claim 6, wherein performing the reservoir simulation analysis includes analyzing gas, oil, and water rate profiles versus time.

8. A non-transitory, computer-readable medium storing one or more instructions executable by a computer system to perform operations comprising:
performing a separator test of a well that is flowing at unstable conditions;
determining, using separator data of the separator test, whether a Turner equation predicts a critical line for a wellbore of the well; and
in response to determining that the Turner Equation does not predict the critical line for the wellbore:
determining, using gas, oil, and water rates from a separator of the well, a water gas ratio (WGR) and a gas liquid ratio (GLR);
when a gas relative permeability (K_{rg}), an oil relative permeability (Kᵣₒ), and a water relative permeability (K_{rw}) are available, adjusting K_{rw} and Kᵣₒ until they match the separator data at critical conditions in a GLR-WGR log-log plot for the well;
otherwise, adjusting a field constant C_{field} until it matches the separator data at critical conditions in a GLR-WGR log-log plot; and
adjusting, based on the WGR, the critical line.

9. The non-transitory, computer-readable medium of claim 8, wherein adjusting the K_{rw} and Kᵣₒ includes using an equation:
$$WGR ≡ 1 , 98 \times {10}^{6} \frac{{k}_{rw}}{[ 2.5 \cdot {k}_{ro} + 2 \cdot {k}_{rw} ]} \cdot {GLR}^{- 1}$$

10. The non-transitory, computer-readable medium of claim 8, wherein adjusting C_{field} includes using an equation:
$$WGR = {C}_{field} \cdot {GLR}^{- 1}$$

11. The non-transitory, computer-readable medium of claim 8, the operations further comprising generating the GLR-WGR log-log plot for the well.

12. The non-transitory, computer-readable medium of claim 8, the operations further comprising:
plotting results of the separator test for a field containing the well; and
defining possible solutions.

13. The non-transitory, computer-readable medium of claim 8, the operations further comprising:
performing one or both of a decline analysis and a reservoir simulation analysis with and without GLR-WGR constraints for the critical line, estimating cumulative hydrocarbon volumes at risk, and estimating a time when this will happen.

14. The non-transitory, computer-readable medium of claim 13, wherein performing the reservoir simulation analysis includes analyzing gas, oil, and water rate profiles versus time.

15. A computer-implemented system, comprising:
one or more processors; and
a non-transitory computer-readable storage medium coupled to the one or more processors and storing programming instructions for execution by the one or more processors, the programming instructions instructing the one or more processors to perform operations comprising:
performing a separator test of a well that is flowing at unstable conditions;
determining, using separator data of the separator test, whether a Turner equation predicts a critical line for a wellbore of the well; and
in response to determining that the Turner Equation does not predict the critical line for the wellbore:
determining, using gas, oil, and water rates from a separator of the well, a water gas ratio (WGR) and a gas liquid ratio (GLR);
when a gas relative permeability (K_{rg}), an oil relative permeability (Kᵣₒ), and a water relative permeability (K_{rw}) are available, adjusting K_{rw} and Kᵣₒ until they match the separator data at critical conditions in a GLR-WGR log-log plot for the well;
otherwise, adjusting a field constant C_{field} until it matches the separator data at critical conditions in a GLR-WGR log-log plot; and
adjusting, based on the WGR, the critical line.

16. The computer-implemented system of claim 15, wherein adjusting the K_{rw} and Kᵣₒ includes using an equation:
$$WGR ≡ 1 , 98 \times {10}^{6} \frac{{k}_{rw}}{[ 2.5 \cdot {k}_{ro} + 2 \cdot {k}_{rw} ]} \cdot {GLR}^{- 1}$$

17. The computer-implemented system of claim 15, wherein adjusting C_{field} includes using an equation:
$$WGR = {C}_{field} \cdot {GLR}^{- 1}$$

18. The computer-implemented system of claim 15, further comprising generating the GLR-WGR log-log plot for the well.

19. The computer-implemented system of claim 15, further comprising:
plotting results of the separator test for a field containing the well; and
defining possible solutions.

20. The computer-implemented system of claim 15, further comprising:
performing one or both of a decline analysis and a reservoir simulation analysis with and without GLR-WGR constraints for the critical line, estimating cumulative hydrocarbon volumes at risk, and estimating a time when this will happen.
